(19) United States
(12) Patent Application Publication
(10) Pub. No.: US 2023/0367884 A1
(43) Pub. Date: Nov. 16, 2023

(54) CYBER ATTACK SCENARIO GENERATION METHOD AND DEVICE

(71) Applicant: Hitachi, Ltd., Tokyo (JP)

(72) Inventors: Takashi OGURA, Tokyo (JP); Junya FUJITA, Tokyo (JP); Tsutomu YAMADA, Tokyo (JP)

(21) Appl. No.: 18/030,027

(22) PCT Filed: Oct. 12, 2021
(86) PCT No.: PCT/JP2021/037782

§ 371 Date: Apr. 3, 2023

(30) Foreign Application Priority Data
Nov. 9, 2020 (JP) 2020-186445

(51) Int. Cl. G06F 21/57

(52) U.S. Cl. CPC G06F 21/577; G06F 2221/034

(57) ABSTRACT

A method of generating an attack scenario by evaluating an attack strategy and a technique based on a characteristic of an attacker, a target system, and the like, and combining an attack strategy and a technique based on the evaluation. In a method of generating a cyber attack scenario including a combination of attack strategy/technique information configured by a plurality of attack strategies and attack techniques for realizing a threat to a target system, an attack strategy/technique evaluation unit 106 calculates an evaluation point for attack strategy/technique information, and an attack strategy/technique combination determination unit 107 generates a cyber attack scenario by combining the attack strategy/technique evaluation unit 106 based on the evaluation point.

### TECHNICAL FIELD

The present invention relates to a technique for generating a cyber attack scenario.

### BACKGROUND ART

Currently, a cyber attack on a computer system (hereinafter, simply the system) such as unauthorized access is a serious problem, and a countermeasure against a cyber attack is essential for safely operating the system. When planning this countermeasure, it is useful to plan a countermeasure based on a cyber attack scenario that simulates the movement of an attacker from the viewpoint that a countermeasure content can be identified and a countermeasure can be placed in the order of priority.

In order to plan a countermeasure based on this cyber attack scenario at the level of a specific countermeasure technique, an attack scenario defining as far as detailed behavior of an attacker such as “attack strategy” or “attack technique” used by the attacker to give “threat” that is a purpose of the attacker is required. This detailed scenario enables planning at a specific countermeasure technique level corresponding to an attack strategy or an attack technique. For this reason, a method and a device for generating an attack scenario defining as far as an attack strategy and an attack technique for realizing a threat are required.

In PTL 1, which is a technique related to a method of generating the attack scenario described above, a threat is evaluated on the basis of a system configuration, damage due to the threat, and the like, and an attack scenario defining as far as an attack strategy and an attack technique is generated for a highly evaluated threat.

### CITATION LIST

### Patent Literature

PTL 1: JP 2020-2198989 A

### SUMMARY OF INVENTION

### Technical Problem

However, in another method of generating an attack scenario of PTL 1, there is a problem that a combination of a strategy and a technique of an attacker for realizing a threat is fixed, and a more effective attack scenario cannot be generated in consideration of a characteristic of an attacker and a target system.

In view of the above, an object of the present invention is to generate an attack scenario by evaluating an attack strategy and an attack technique according to a characteristic of an attacker and a target system, and combining an attack strategy and a technique on the basis of the evaluation.

### Solution to Problem

In order to solve the above problem, the present invention generates an “attack scenario” that is a combination of a plurality of attack strategies and attack techniques on the basis of system configuration information in relation to an attack that poses a threat to a target system. At this time, a combination of an attack strategy and an attack technique, that is, an “attack scenario” is determined on the basis of an evaluation point of the attack strategy and the attack technique.

A more detailed configuration of the present invention is a cyber attack scenario generation method using a scenario generation device that generates a scenario of a cyber attack on a computer system. The cyber attack scenario generation method includes reading, from a storage device, a plurality of pieces of attack strategy/technique information in which an attack strategy indicating an action for executing the cyber attack and an attack technique indicating a method of realizing the attack strategy are associated, evaluating effectiveness of a cyber attack in each of a plurality of pieces of the attack strategy/technique information, and identifying a combination of the attack strategy/technique information according to a result of the evaluation, and generating an attack scenario configured by an identified combination.

Further, the present invention includes a scenario generation device that executes the cyber attack scenario generation method. Furthermore, a computer program for causing a computer to execute the cyber attack scenario generation method and a storage medium storing the computer program are also included.

### Advantageous Effects of Invention

According to the present invention, it is possible to flexibly generate an attack scenario at an attack strategy and attack technique level according to a characteristic of an attacker, a target system, and the like.

An object, a configuration, and an advantageous effect other than those described above will be clarified in description of an embodiment described below.

### BRIEF DESCRIPTION OF DRAWINGS

FIG. 1 is a functional block diagram illustrating an example of a functional configuration of a scenario generation device according to a first embodiment.

FIG. 2 is a system configuration diagram of the scenario generation device according to the first to third embodiments.

FIG. 3A is a diagram illustrating an example of system configuration information used in the first to third embodiments.

FIG. 3B is a diagram illustrating an example of path information used in the first to third embodiments.

FIG. 4 is a diagram illustrating an example of threat information used in the first to third embodiments.

FIG. 5 is a diagram illustrating an example of attack strategy/technique information used in the first and second embodiments.

FIG. 6 is an example of a flowchart for explaining an attack scenario generation method according to the first to third embodiments.

FIG. 7 is an example of a flowchart illustrating details of Step S604 of FIG. 6 according to the first to third embodiments.

FIG. 8 is a diagram illustrating an example of a system configuration of an attack target according to the first to third embodiments.

FIG. 9 is an example of a graph diagram obtained by abstracting the system configuration of an attack target according to the first to third embodiments.

FIG. 10 is a diagram illustrating an example of evaluation of threat information according to the first to third embodiments.

FIG. 11 is a diagram illustrating an example of evaluation of attack strategy/technique information according to the first embodiment.

FIG. 12 is a diagram illustrating an example of display of an attack scenario generation result according to the first to third embodiments.

FIG. 13 is a diagram illustrating an example of a plurality of generated attack scenarios according to the first to third embodiments.

FIG. 14 is a diagram illustrating an example of screen display of a generated attack scenario according to the first to third embodiments.

FIG. 15 is a functional block diagram illustrating an example of a functional configuration of the scenario generation device according to the second embodiment.

FIG. 16 is a diagram illustrating an example of trend analysis information according to the second embodiment.

FIG. 17 is a diagram illustrating an example of threat evaluation information according to the second embodiment.

FIG. 18 is a diagram illustrating an example of attack strategy/technique evaluation information according to the second embodiment.

FIG. 19 is a diagram illustrating an example of a generated attack scenario generation result according to the second embodiment.

FIG. 20 is a functional block diagram illustrating an example of a functional configuration of the scenario generation device according to the third embodiment.

FIG. 21 is a diagram illustrating an example of attack strategy/technique information used in the third embodiment.

FIG. 22 is a diagram illustrating a concept of an attack scenario in the first to third embodiments.

### DESCRIPTION OF EMBODIMENTS

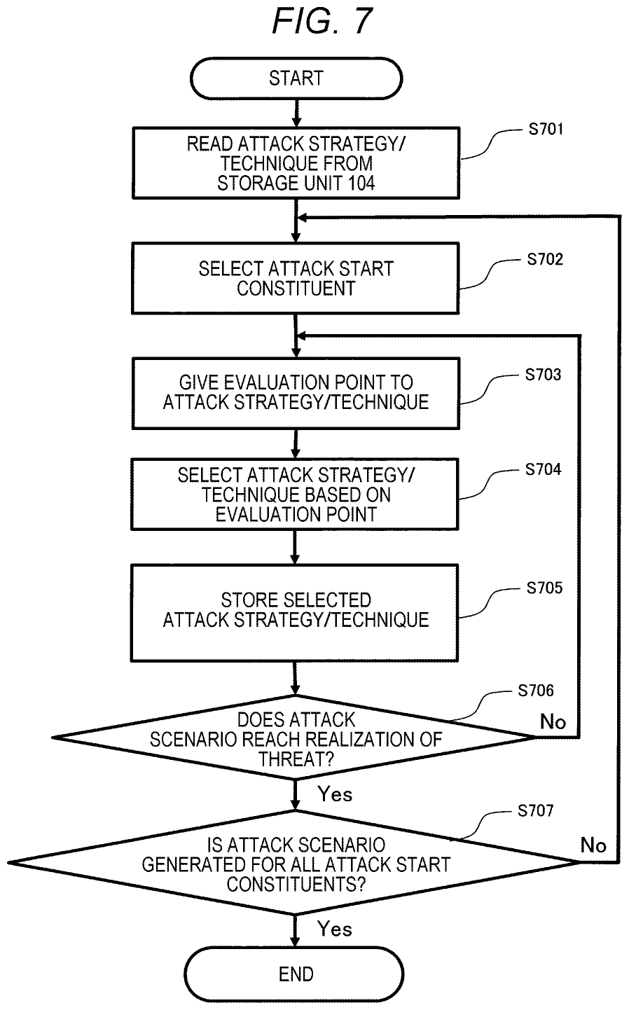

Hereinafter, each embodiment of the present invention will be described with reference to the drawings. In each embodiment, an attack scenario of a cyber attack on a system to which each constituent as illustrated in FIG. 8 is connected is generated. Note that the constituents include a notebook PC 802 and the like, and a specific configuration of the system will be described later.

### First Embodiment

Hereinafter, a first embodiment according to the present invention will be described with reference to the accompanying drawings.

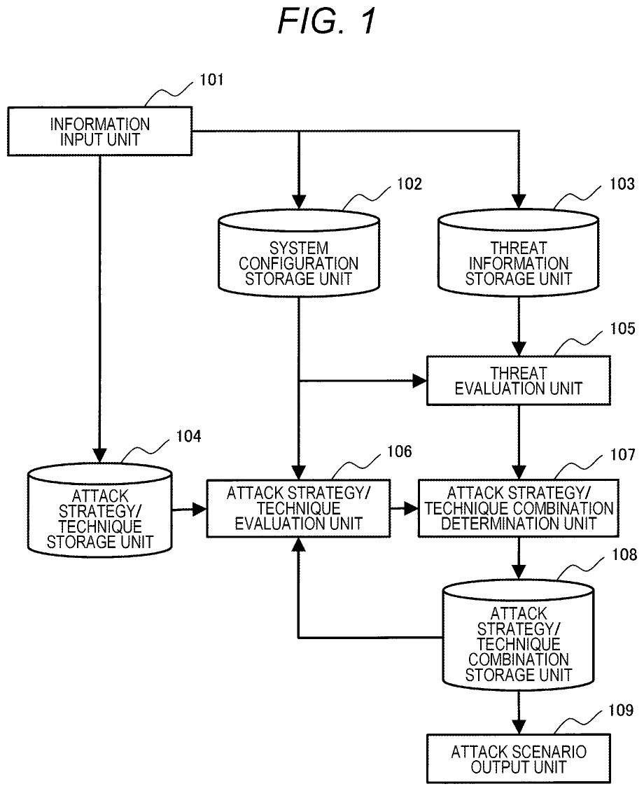

FIG. 1 is a functional block diagram illustrating a functional configuration of a scenario generation device 20 that generates an attack scenario of the present embodiment. Hereinafter, each block (function) will be described. An attack target system configuration storage unit 102 stores system configuration information 300 of an attack target. A threat information storage unit 103 stores threat information 400 of a cyber attack. An attack strategy/technique storage unit 104 stores attack strategy/technique information 500 for realizing a threat.

The system configuration information 300, the threat information 400, and the attack strategy/technique information 500 are input from an information input unit 101. A threat evaluation unit 105 evaluates the risk of each threat for each system constituent on the basis of the system configuration information 300 of the attack target system configuration storage unit 102 and the threat information 400 of the threat information storage unit 103. For this reason, the threat evaluation unit 105 calculates, for example, an evaluation point indicating a risk. Note that, in the present description, the expression, evaluation point, is used, but any expression such as evaluation value and evaluation index may be used as long as the expression indicates an index of evaluation.

An attack strategy/technique evaluation unit 106 calculates an evaluation point on the basis of the information of the system configuration storage unit 102, the attack strategy/technique storage unit 104, and an attack strategy/technique combination storage unit 108 in which a state during generation of an attack scenario is stored. This evaluation point indicates effectiveness of an attack in each piece of the attack strategy/technique information 500. An attack strategy/technique combination determination unit 107 determines a combination of an attack strategy constituting an attack scenario and a technique by using an evaluation point calculated by the attack strategy/technique evaluation unit 106.

The attack strategy/technique combination storage unit 108 stores a state during generation of an attack scenario and an attack scenario that has been generated. Then, an attack scenario output unit 109 outputs and displays an attack scenario that has been generated stored in the attack strategy/technique combination storage unit 108. Note that each storage unit and calculation unit may be a CPU or a PC itself.

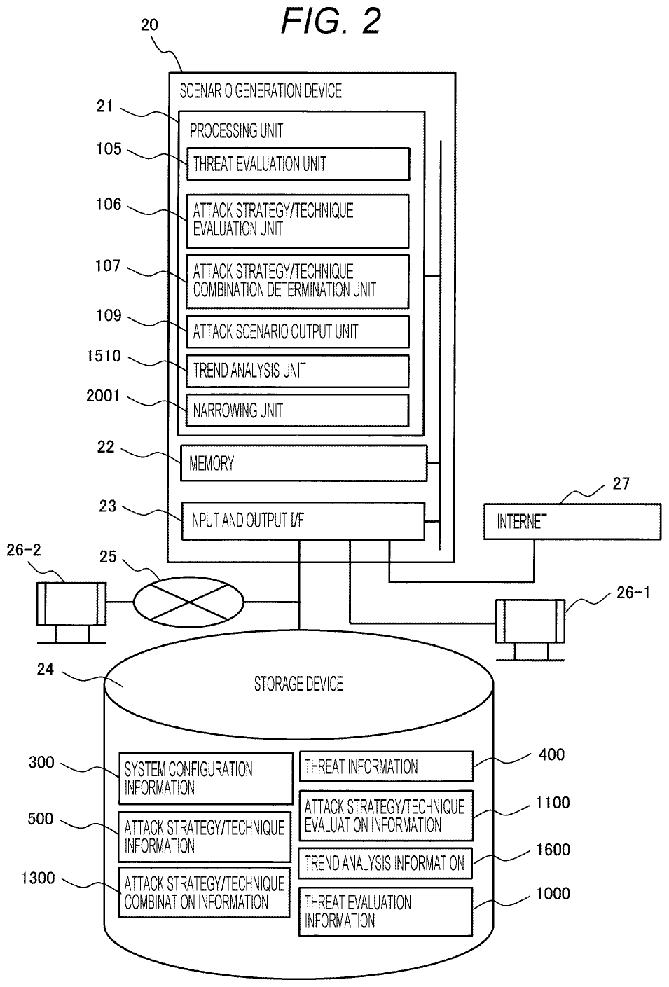

FIG. 2 illustrates a system configuration diagram in which a functional configuration of the scenario generation device 20 described above is realized by a computer. The scenario generation device 20 includes a processing unit 21 such as a CPU, a memory 22, and an input and output I/F 23 connected to each other by a bus or the like. Here, the processing unit 21 includes the threat evaluation unit 105, the attack strategy/technique evaluation unit 106, the attack strategy/technique combination determination unit 107, the attack scenario output unit 109, and a trend analysis unit 1510, which can be realized by a program. That is, in the present embodiment, a program is loaded into the memory 22, and these functions and calculation are executed by the processing unit 21.

Further, the scenario generation device 20 is connected to a storage device 24 via the input and output I/F 23. The storage device 24 stores the system configuration information 300, the threat information 400, threat evaluation information 1000, the attack strategy/technique information 500, attack strategy/technique evaluation information 1100, attack strategy/technique combination information 1300, and trend analysis information 1600. That is, the storage device 24 functions as the system configuration storage unit 102, the threat information storage unit 103, and the attack strategy/technique storage unit 104 in FIG. 1. Further, the storage device 24 may be provided inside the scenario generation device 20.

Note that the trend analysis unit 1510 and the trend analysis information 1600 are information used in a second embodiment, and do not need to be stored in the storage device 24 in the present embodiment. Furthermore, in the second embodiment to be described later, in the storage device 24, threat evaluation information 1700 is stored instead of the attack strategy/technique evaluation information 1100, and attack strategy/technique evaluation information 1800 is stored instead of the attack strategy/technique combination information 1300. Further, a narrowing unit 2001 is used in a third embodiment, and does not need to be used in the present embodiment. In the third embodiment, instead of the attack strategy/technique information 500, attack strategy/technique information 2100 is stored in the storage device 24.

Further, the scenario generation device 20 is connected to various terminal devices 26-1 and 26-2 via the input and output I/F 23. Each of the terminal devices 26-1 and 26-2 is realized by a computer, and has a function of receiving input from the user and displaying a processing result of the scenario generation device 20. That is, the terminal devices 26-1 and 26-2 function as the information input unit 101 and the attack scenario output unit 109 in FIG. 1. Further, the terminal device 26-2 is connected to the scenario generation device 20 via a network 25. Note that the terminal devices 26-1 and 26-2 may be integrated with the scenario generation device 20. That is, the scenario generation device 20 may be provided with a display device and an input and output device. In a case of being configured as a constituent of the present system, the notebook PC 801, a desktop PC 802, or a data server 803 has a function of the scenario generation device 20.

Further, the scenario generation device 20 can also be connected to Internet 27 to acquire external information. As an example, a system to be verified may be connected via the Internet 27, and the system configuration information 300 may be received from the system.

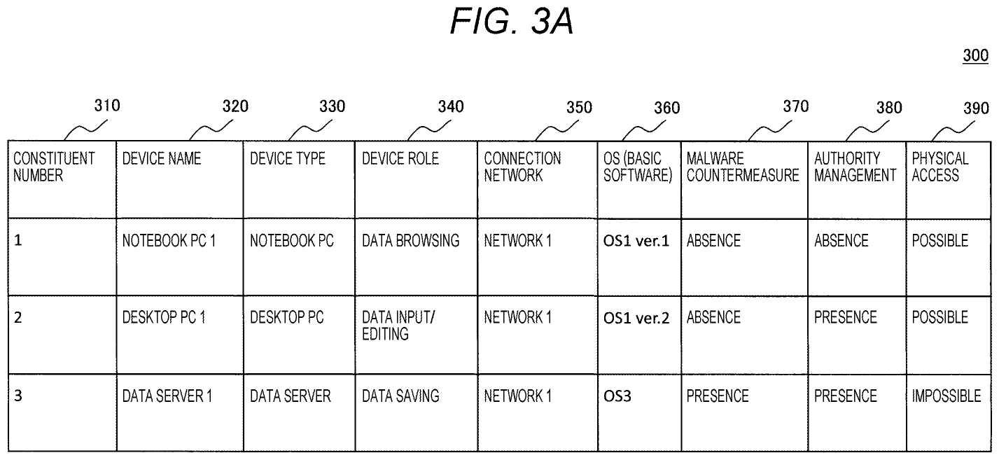

FIG. 3A is a diagram illustrating the system configuration information 300 stored in the system configuration storage unit 102. The system configuration information 300 includes various types of information regarding each constituent constituting a system of an attack target. The system configuration information 300 is information in which a constituent number 310, a device name 320, a device type 330, a device role 340, a connection network 350, an installed OS 3650, a malware countermeasure 370, authority management 380, and a physical access 390 are associated with each constituent.

The element number 310 is an identifier uniquely representing a constituent of the system. The device name 320 is a name of a device, that is, a constituent, and, in the example illustrated in FIG. 3A, is a notebook PC 1, a desktop PC 1, a data server 1, and the like. In addition, the device includes a smartphone, a tablet terminal, and the like. The device type 330 indicates a type of a device, that is, a constituent constituting the system. In the example of FIG. 3A, a notebook PC, a desktop PC, and a data server are used.

The device role 340 indicates a role played by the device, and is data browsing, data input/editing, data saving, or the like in the example of FIG. 3A. The connection network 350 is a network to which each constituent is connected, and in the example of FIG. 3A, there are two networks of a network 1 and a network 2.

The OS (basic software) 360 is a type and version of an OS (basic software) mounted on each constituent, and in the example of FIG. 3A, OS 1 ver. 1, OS 1 ver. 2, OS 3, and the like are exemplified. The malware countermeasure 370 indicates the presence or absence of a countermeasure against malware in each constituent. That is, in the example of FIG. 3A, the case of presence indicates that a countermeasure is taken for a constituent of the system, and the case of absence indicates that no countermeasure is taken for the constituent. The authority management 380 indicates the presence or absence of authority management in each constituent, and in the example of FIG. 3A, the case of presence indicates that management is performed, and the case of absence indicates that no management is performed. The physical access 390 indicates whether an attacker can physically contact a corresponding crisis, and the example of FIG. 3A indicates that it is possible to contact the notebook PC 1 and the desktop PC 1 but not possible to contact the data server 1.

Here, the device role 340, the OS (basic software) 360, the malware countermeasure 370, the authority management 380, and the physical access 390 are information indicating a countermeasure status against a cyber attack.

For this reason, as will be described later, the threat evaluation unit 105 and the attack strategy/technique evaluation unit 106 use information indicating a countermeasure status in Step S602 and Step S703 for performing each evaluation.

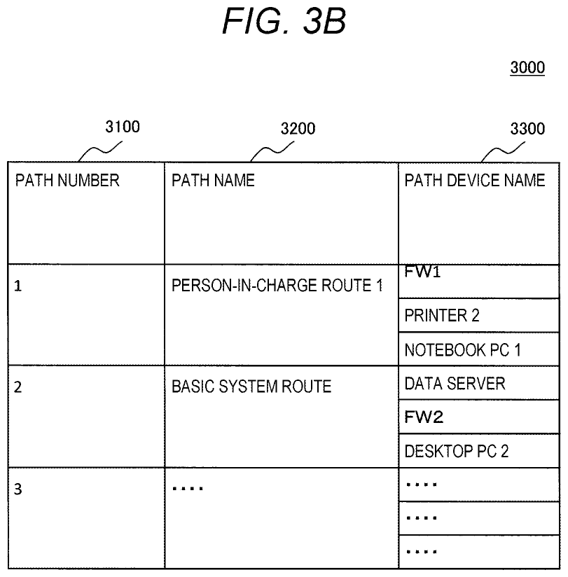

FIG. 4 is a diagram illustrating the threat information 400 stored in the threat information storage unit 103. The threat information 400 is information in which a boundary dead number 410 and threat content 420 are associated with each threat. The threat content 410 indicates a purpose of an attacker. In the case of the example of FIG. 4, the threat content 410 includes falsification of data, stealing of data, disabling of data editing, and destroying of a device.

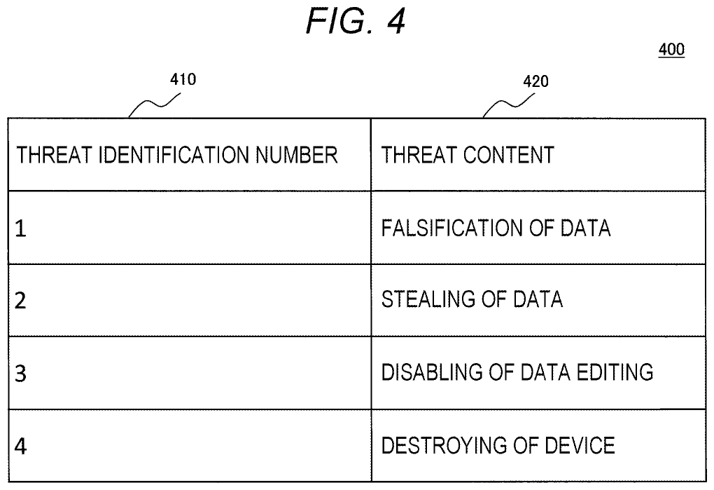

FIG. 5 is a diagram illustrating the attack strategy/technique information 500 stored in the attack strategy/technique storage unit 104. The attack strategy/technique information 500 includes an attack strategy identification number 510, an attack strategy name 520, an attack technique identification number 530, and an attack technique name 540. The attack strategy name includes an assumed attack strategy, and in the case of the example of FIG. 5, there are an initial intrusion, execution of an attack code, authority promotion, movement to another element, authentication information access, information collection, and taking out of data. The attack technique name 540 is a technique for realizing an attack strategy. In the example of FIG. 3A, items below are included.
Fishing mail
Connection of a physical device
Use of a command line and use of Application Programing Interface (API)
Use of a buffer error
Bypassing of authority management
Management sharing
Remote file copy
Brute-force attack or account manipulation
Key logging
Data of a local system
Use of communication in a standard protocol
Taking out by a physical device

Note that path information 3000 illustrated in FIG. 3B may be used instead of the system configuration information 300. That is, the path information 3000 indicating an intrusion route of a cyber attack can also be used. The path information 3000 has an item below for each path number 3100 for identifying this intrusion route, that is, a path. That is, a path name 3200 which is a name of an intrusion route and a path device name 3300 which identifies a device present in the intrusion route are included. Using the path information 3000, evaluation processing in the threat evaluation unit 105 and the attack strategy/technique evaluation unit 106 is executed. Further, both the system configuration information 300 and the path information 3000 may be used in the evaluation processing of these.

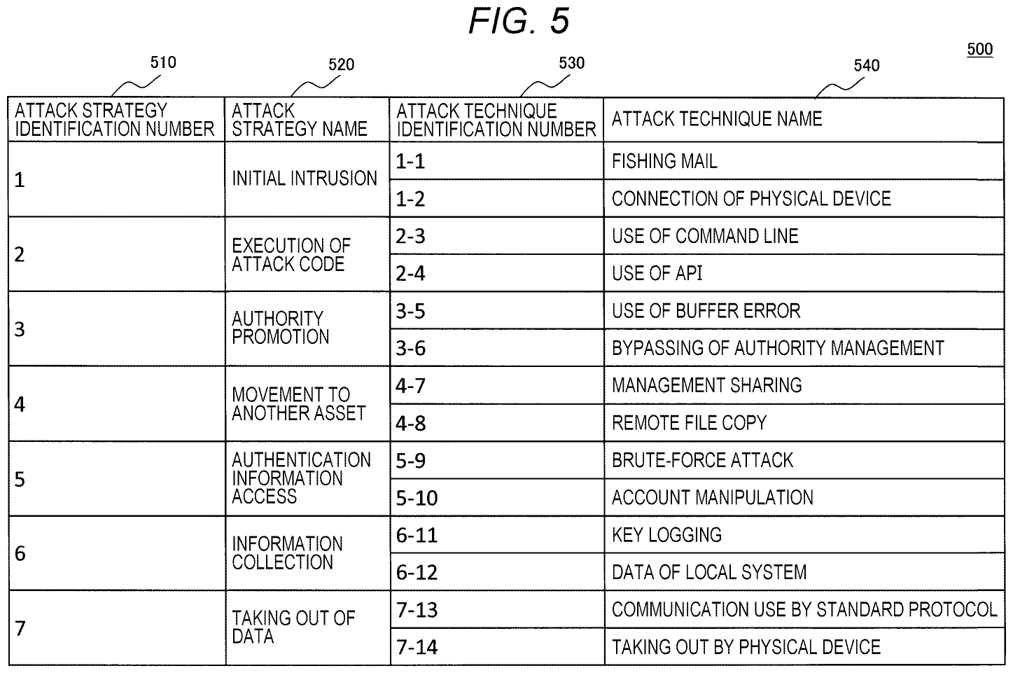

FIG. 6 is an overall process of an attack scenario generation method in the present embodiment. Hereinafter, the overall free will be described using a functional block illustrated in FIG. 1.

First, in Step S601, the threat evaluation unit 105 reads the system configuration information 300 from the system configuration storage unit 102. Further, in Step S602, the threat evaluation unit 105 reads the threat information 400 from the threat information storage unit 103, and evaluates each piece of the threat information 400 for each constituent. At the time of this evaluation, the risk of each piece of the threat information 400 is assigned as an evaluation point on the basis of the device role 340 and the like of the system configuration information 300. Then, in Step S603, a combination of a constituent of an attack target for which an attack scenario is generated and the threat information 400 is selected on the basis of the evaluation point in Step S602.

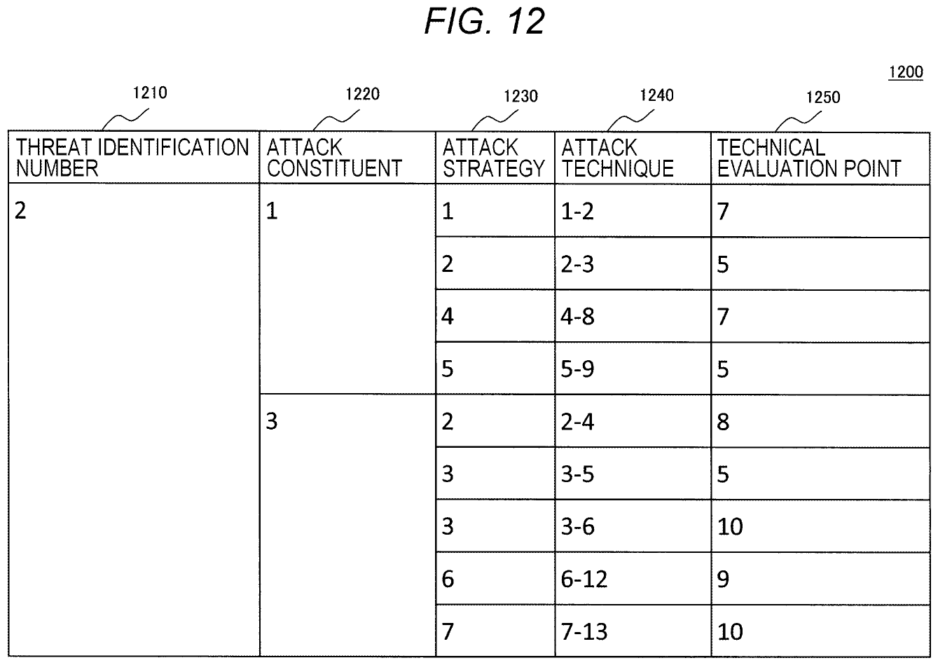

As a selection method of Step S603, there are a method of selecting in ascending order of evaluation points, a method of determining a threshold of an evaluation point and selecting a combination of a constituent and the threat information 400 having an evaluation point equal to or more than the threshold, and the like. In a generated attack scenario example illustrated in FIG. 12 to be described later, an example in which an evaluation point threshold is set to four is illustrated. Then, in Step S604, the attack strategy/technique combination determination unit 107 and the attack strategy/technique evaluation unit 106 generate an attack scenario that is a combination of the attack strategy/technique information 500 that realizes the threat content 420 of the threat information 400 selected in Step S603. That is, the attack strategy/technique combination determination unit 107 and the attack strategy/technique evaluation unit 106 can function as an attack scenario generation unit.

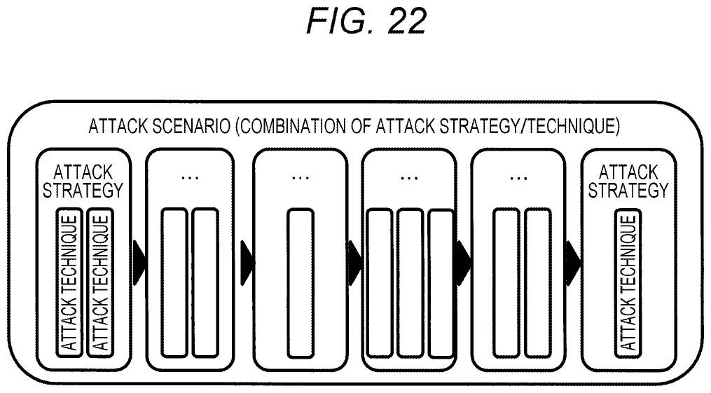

Here, a concept of this attack scenario is illustrated in FIG. 22. As illustrated in FIG. 22, an attack scenario includes a plurality of pieces of the attack strategy/technique information 500, that is, a combination of these (in FIG. 22, the attack strategy/technique information 500 is described as attack strategy/technique). Further, the attack strategy/technique information 500 is information in which an attack strategy and an attack technique are associated with each other, and specific content of the information is as illustrated in FIG. 5.

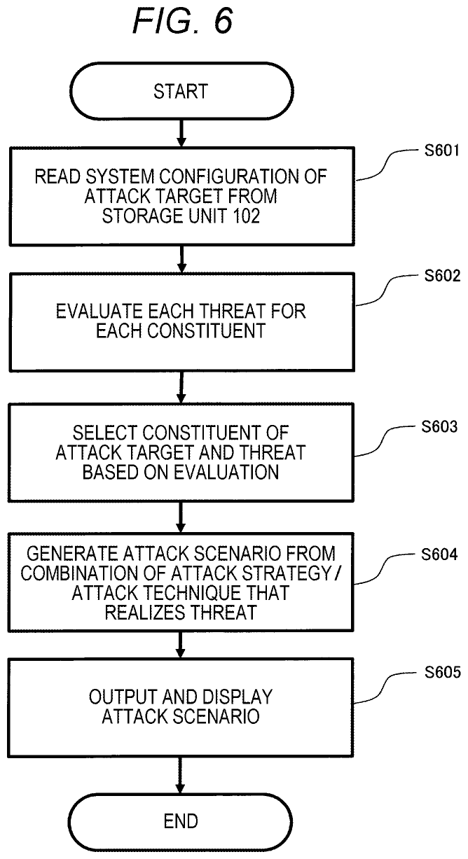

Note that a specific method of generating an attack scenario will be described later with reference to FIG. 7. Finally, in Step S605, the attack scenario output unit 109 outputs and displays the generated scenario.

FIG. 7 is a flowchart illustrating details of Step S604.

First, in Step S701, the attack strategy/technique evaluation unit 106 reads the attack strategy/technique information 500 from the attack strategy/technique storage unit 104. Then, in Step S702, an attack start constituent is selected. Then, in Step S703, an evaluation point for the read attack strategy/technique information 500 is calculated.

Next, in Step S704, the attack strategy/technique combination determination unit 107 selects the attack strategy/technique information 500 on the basis of the evaluation points. For example, it is possible to select information having an evaluation point of a predetermined value or more or a predetermined number of pieces of information having higher evaluation points.

Then, in Step S705, the selected attack strategy/technique information 500 is stored in the attack strategy/technique combination storage unit 108. Note that the present step may be omitted, and the attack strategy/technique information 500 selected in Step S704 may be used in subsequent processing.

Next, in Step S706, whether an attack scenario being generated reaches realization of the corresponding threat content 420. In a case where the attack scenario is determined not to reach realization (Step S706: No), the processing proceeds to Step S703 to select the subsequent attack strategy/technique information 500.

On the other hand, in a case where the attack scenario is determined to reach realization of the threat content 420 (Step S604: Yes), the processing proceeds to Step S707. Then, in Step S707, whether an attack scenario is generated for each assumed attack start constituent is determined for the combination of a constituent of an attack target and the threat information 400 selected in Step S603. In a case where a scenario group generated up to this point does not include all attack start constituents (Step S707: No), the processing proceeds to Step S702, and an attack start constituent that is not generated is selected. On the other hand, in a case all the constituents are generated (Step S707: Yes), the generation of an attack scenario ends.

Next, content of the scenario generation method according to the present embodiment will be described using a specific example. First, a specific example of a system configuration as an attack target, that is, an evaluation target for a risk level is illustrated in FIG. 8. This system includes, as constituents, the notebook PC 801, the desktop PC 802, and the data server 803.

Then, each constituent is connected to another constituent as described below. The notebook PC 401 is connected to the desktop PC 802 and the data server 803. The desktop PC 802 is connected to the notebook PC 801 and the data server 803. The data server 803 is connected to the notebook PC 801 and the desktop PC 802. Note that the above 401 to 403 correspond to 1 to 5 of the element number 310 in FIG. 3.

Further, the scenario generation device 20 may be connected to the present system or may be realized as a constituent of the present system. In a case of being configured as a constituent of the present system, the notebook PC 801, a desktop PC 802, or a data server 803 has a function of the scenario generation device 20.

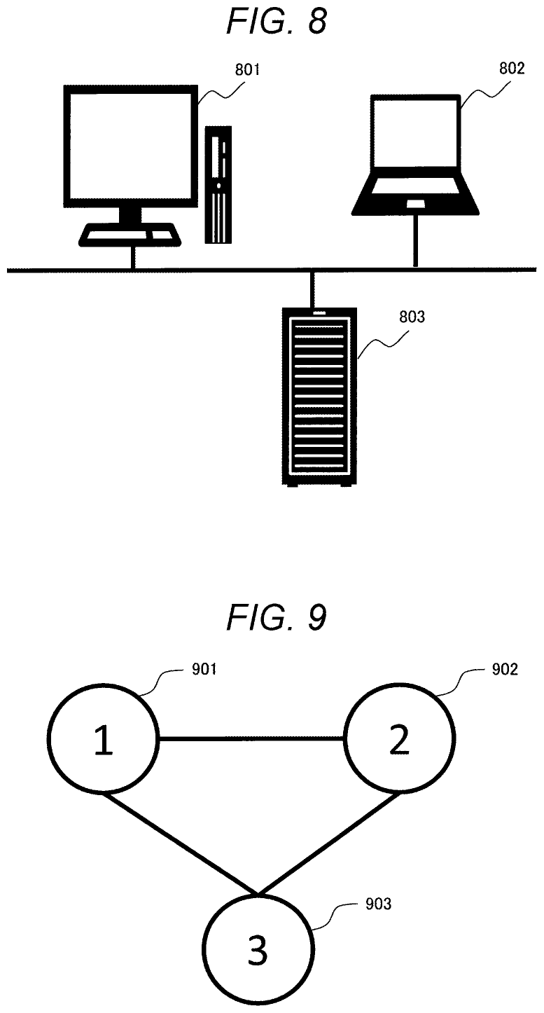

FIG. 9 is a graph diagram obtained by abstracting a system configuration of an attack target of FIG. 8. That is, FIG. 9 illustrates topology indicating a connection status of each constituent of a system of a target.

In FIG. 9, a node 901 of Constituent number 1 corresponds to the notebook PC 801 of FIG. 8. A node 902 of Constituent number 2 corresponds to the notebook PC 802 of FIG. 8. A node 903 of Constituent number 3 corresponds to the data server 803 in FIG. 8. Hereinafter, content of the scenario generation method of the present embodiment will be described using the graph diagram of FIG. 9.

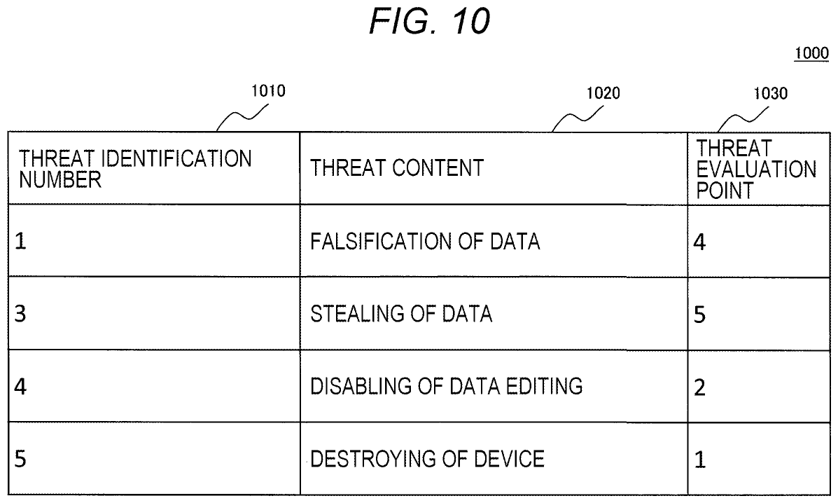

FIG. 10 illustrates an example of the threat evaluation information 1000 evaluated by the threat evaluation unit 105 in Step S602. FIG. 10 is an example of associating a threat identification number 1010, threat content 1020, and a threat evaluation point 1030. In the example of FIG. 10, the data server 803 of the node 903 in FIG. 9 is selected as a constituent to be evaluated. Since the data server 803 is responsible for data saving as the device role 340, there is a high risk of “falsification of data” or “stealing of data”, and high evaluation (high risk) is given to these pieces of the threat information 1010. That is, the evaluation point has a relatively high score.

Hereinafter, in order to describe Step S604 and a process of FIG. 7, it is assumed that in Step S603, a constituent of an attack target is the node 903 in FIG. 9, and Threat identification number 2 “stealing of data” is selected as the threat content 1020 of the threat information 1010.

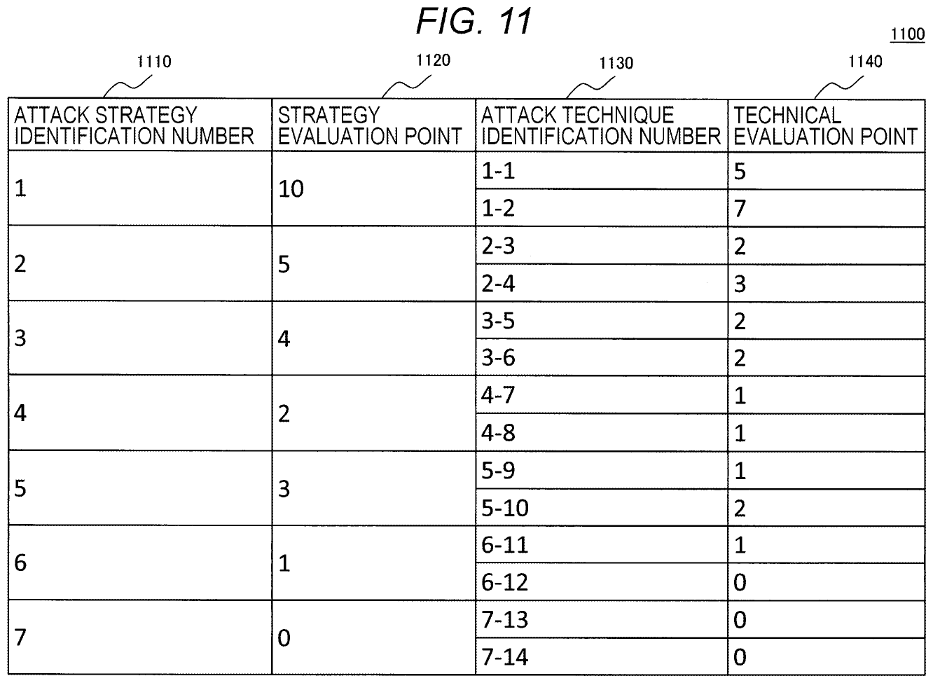

FIG. 11 illustrates the attack strategy/technique evaluation information 1100 assigned by the attack strategy/technique evaluation unit 106 in Step S703 in a case where a notebook PC of Constituent number 1 is selected as an attack start constituent in Step S702 under the above-described condition. The attack strategy/technique evaluation information 1100 in FIG. 11 is an example in which an attack strategy identification number 1110, a strategy evaluation point 1120, an attack technique identification number 1130, and a technical evaluation point 1140 are associated with each other. FIG. 11 illustrates an example of evaluation when selection of the attack strategy/technique information 500 performed as an initial stage of an attack scenario is performed in the present embodiment. A technical evaluation point is calculated on the basis of the system configuration information 300 and a stage of attack.

In FIG. 11, an attack technique “connection of a physical device” of an attack strategy “initial intrusion” has a highest evaluation point. This is based on the fact that it is at an initial stage of attack, and, as a characteristic of an attacker, there is a characteristic that intrusion (initial intrusion) is attempted first, and that, since a constituent of a target is a notebook PC, connection of a physical device is easy. In the present embodiment, the strategy evaluation point 1120 is given by adding the strategy evaluation points 1120 of a corresponding attack strategy. However, the present invention is not limited to this, and the strategy evaluation point 1120 can be given by multiplication or a difference in the technical evaluation points 1140 of a corresponding attack strategy.

Alternatively, it is also possible to assign the strategy evaluation point 1120 independently of a technical evaluation point. On the basis of this evaluation point, the attack strategy/technique information 500 is selected and combined, so that an attack scenario is generated. In the present embodiment, as a selection method, one having a highest evaluation point among evaluation points at a corresponding stage is selected. In the example of FIG. 11, the attack technique “connection of a physical device” of the attack strategy “initial intrusion” is selected.

However, as a method of selecting the attack strategy/technique information 500, there is also a method of selecting the attack strategy/technique information 500 having an evaluation point equal to or more than a threshold in addition to selecting one having a largest value as described in the present embodiment. In the case of this method, even for an attack scenario regarding the same threat information 1010 for the same attack start and target constituent, attack scenarios having different pieces of the attack strategy/technique information 500 are generated.

Further, there is also a method of calculating an evaluation point by addition with, multiplication by, or a difference from an evaluation point up to a previous stage, or based on a representative value such as an average value, a median value, a geometric mean, or a logarithmic mean. In a case where the strategy evaluation point 1120 is assigned independently of the technical evaluation point 1140, there is also a method of first selecting an attack strategy based on the strategy evaluation point 1120 and selecting an attack technique from attack techniques in the selected attack strategies using the technical evaluation point 1140.

FIG. 12 illustrates an example of an attack scenario generation result 1200. The attack scenario generation result 1200 in FIG. 12 is an example of associating a threat identification number 1210 for identifying threat information corresponding to a generated attack scenario, an attack constituent 1220 indicating a constituent to be attacked, an attack strategy 1230, an attack technique 1240, and a technical evaluation point 1250. In the present embodiment, the attack strategy/technique information 500 having a highest evaluation point is selected from the attack strategy/technique evaluation information 1100 in each attack stage.

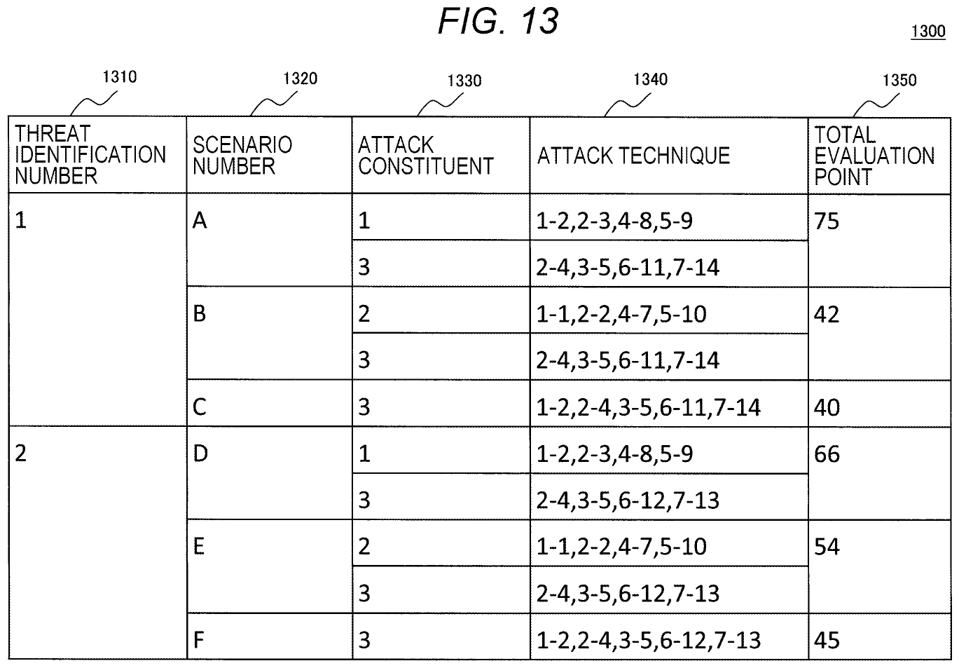

FIG. 13 illustrates an example of a plurality of generated attack scenarios. FIG. 13 illustrates an example in which items below are included as an attack scenario.
A threat identification number 1310 identifying threat information to which an attack scenario corresponds
An attack scenario number 1320 identifying a generated attack scenario
An attack constituent 1330 indicating a constituent to be attacked
An attack technique 1340 indicating an attack technique used in an attack scenario
A total evaluation point 1350 indicating an attack of an evaluation point of each scenario.

In the present embodiment, FIG. 13 illustrates the total evaluation point 1350, and a total evaluation point of Scenario D indicates the sum of the technical evaluation points 1250 of FIG. 12. Note that FIG. 13 is not limited to the total evaluation point 1350, and a representative value such as a multiplication value, an average value, a median value, a geometric mean, and a logarithmic mean may be used.

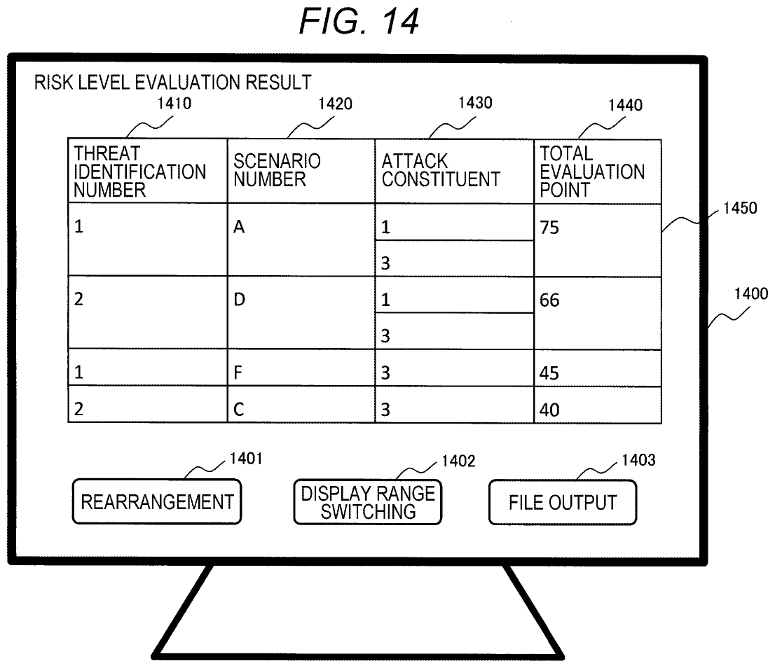

FIG. 14 illustrates a screen display example 1400 of a generated attack scenario. The screen display example 1400 of an attack scenario includes a table 1450. Then, the table 1450 includes a threat identification number 1410, a scenario number 1420, an attack constituent 1430, and a total evaluation point 1440. Further, a rearrangement button 1401 for rearranging attack scenarios, a display range switching button 1402 for adjusting an attack scenario to be displayed on the screen, and a file output button 1403 for outputting the table 1450 as a file are included. In the example of FIG. 14, total evaluation points are rearranged in descending order, and a display range does not include Constituent number 2 in the attack constituent 1430. Note that not only the total evaluation point but also the number of the threat identification numbers 1410, the scenario numbers 1420, and the attack constituents 1430, and the like can be used as a criterion for rearrangement. Further, the order can be rearranged according to the threat evaluation point 1030 and the number of the attack techniques 1340 used in each scenario, which are not associated with the table 1450. Also in display range switching, the range can be switched by the threat identification number 1410, the scenario number 1420, and the total evaluation point 1440. Further, it is also possible to switch a range of attack scenarios to be displayed by the attack strategy 1230 or the attack technique 1240 used in each scenario that is not associated with the table 1450. Note that, in the present embodiment, a total evaluation point is illustrated in the table 1400 of FIG. 14, but the present invention is not limited to the total, and rearrangement or display switching may be performed by using a representative value such as a multiplication value, an average value, a median value, a geometric mean, a logarithmic mean, or the like.

The description of the present embodiment is thus completed. According to the attack scenario generation method of the present embodiment, by using a total value of constituent risk level evaluation points, the possibility of an attack that is made with respect to a process is evaluated, and efficiency of an attack is evaluated by division by the number of passing constituents. For this reason, it is possible to evaluate a risk level of an attack scenario based on a behavior habit of an attacker.

### Second Embodiment

Hereinafter, a second embodiment according to the present invention will be described with reference to the accompanying drawings. Strategies and techniques of a cyber attack are constantly progressing, and there is a need for a method of generating an attack scenario corresponding to them. Further, an attacker or an attack group is identified to some extent depending on an industrial field related to a target system, and a method of generating an attack scenario reflecting these pieces of information is required in order to take measures more efficiently. For this reason, in the present embodiment, a method of generating an attack scenario in which a function of trend analysis of a cyber attack is added to the method described in the first embodiment will be described.

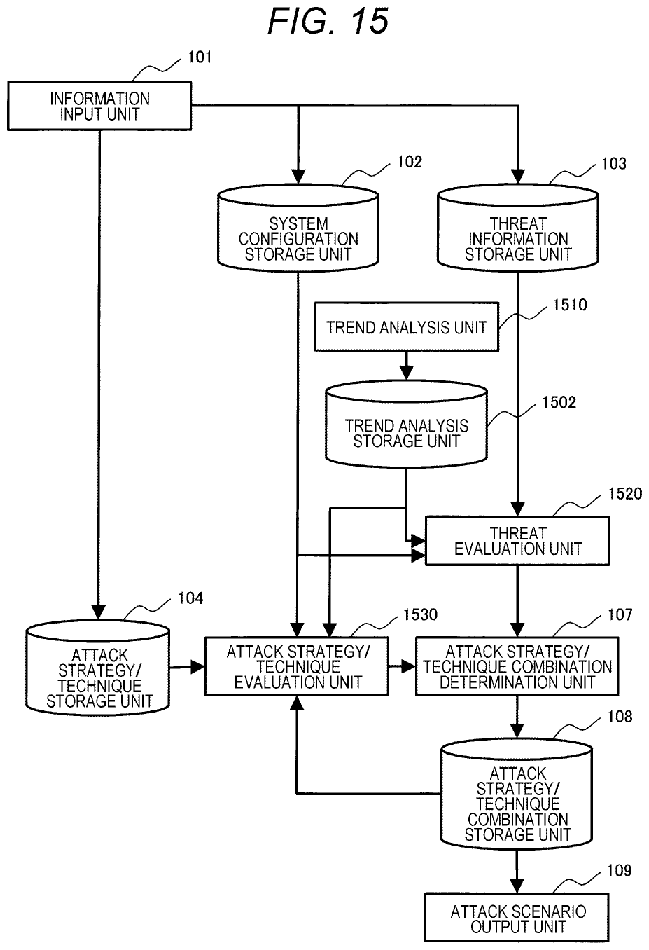

The present embodiment is different in that a trend analysis unit 1510 and a trend analysis storage unit 1502 are added to the attack scenario generation device of FIG. 1 described in the first embodiment. FIG. 15 illustrates a functional block diagram illustrating an example of a functional configuration of the scenario generation device 20 in the present embodiment. In FIG. 15, reference numerals 101 to 104 and 107 to 109 are the same as those in FIG. 1. The trend analysis unit 1510 is included in the scenario generation device 20 in FIG. 2, and the trend analysis storage unit 1502 includes the trend analysis information 1600 in the storage device 24 in FIG. 2. The trend analysis information 1600 is input to a threat evaluation unit 1520 and an attack strategy/technique evaluation unit 1530, and is used to evaluate threat information and the attack strategy/technique information 500.

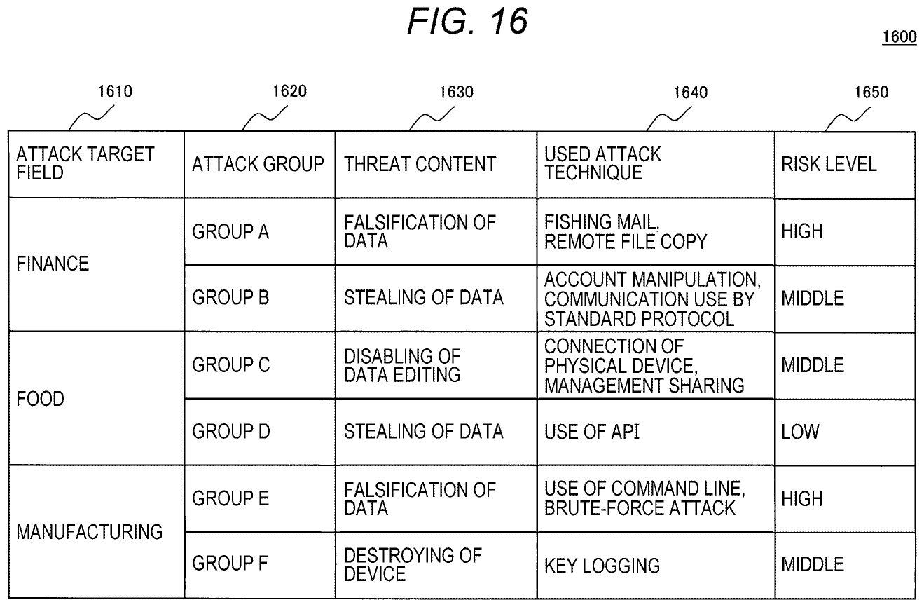

FIG. 16 is a diagram illustrating an example of the trend analysis information 1600. The trend analysis information 1600 is information in which an attack target field 1610, an attack group 1620, threat content 1630, a used attack technique 1640, and a risk level 1650 are associated. The threat content 1630 indicates content of a threat intended by each group, and includes falsification of data, stealing of data, disabling of data editing, and destroying of a device. The threat content 1630 is associated with the threat content 420 in FIG. 4. The attack target field is an industrial field that receives a cyber attack, and includes finance, food, and manufacturing.

Further, the used attack technique 1640 is an attack technique having a record of use by each group in a past attack. Then, there are fishing mail, remote file copy, account manipulation, communication use of a standard protocol, connection of a physical device, management sharing, use of an API, use of a command line, brute-force attack, and key logging, which are associated with the attack technique name 540 in FIG. 5. The risk level 1650 is obtained by evaluating how much a technique each attack group has and how much influence is given in three stages of high, medium, and low.

These pieces of information are obtained by analyzing a past attack case and a latest attack case. As a method of obtaining information of a case, there is acquisition of information from the Internet. Alternatively, the information can be obtained by using a past case of a security measure. As a method of analysis, there are a method using simple statistical processing and a method using machine learning and AI.

An entire process of attack scenario generation in the present embodiment is the entire process illustrated in FIG. 7 similarly to the first embodiment. Hereinafter, the present embodiment will be described using an example when Group A is selected as a reflection trend from the trend analysis information 1600.

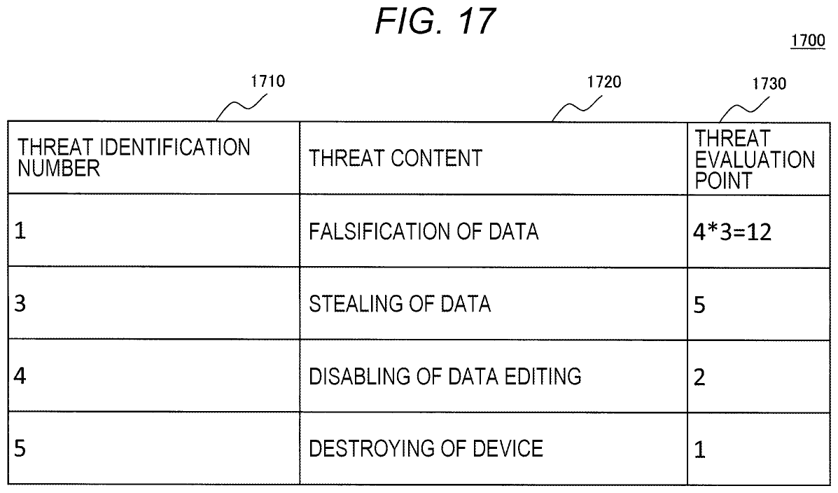

FIG. 17 illustrates an example of the threat evaluation information 1700 evaluated by the threat evaluation unit 1520 in Step S602 in the present embodiment. FIG. 17 is an example of associating threat identification number 1710, threat content 1720, and a threat evaluation point 1730. In the example of FIG. 17, the data server 803 of the node 903 in FIG. 9 is selected as a constituent to be evaluated, and as a difference from the first embodiment, Group A is selected as a threat trend from the trend analysis information 1600. Since the data server 803 is responsible for data saving as the device role 340, there is a high risk of “falsification of data” or “stealing of data”, and high evaluation (high risk) is given to these pieces of threat information. Furthermore, in the trend analysis information 1600, Group A is a group with the risk level 1650 of “high” associated with threat information of “falsification of data”. For this reason, in the threat evaluation point 1730, 12 obtained by multiplying the original value 4 by three is set as a threat evaluation point of “falsification of data” of Threat identification number 1. Hereinafter, in order to describe Step S604 and the process of FIG. 7, it is assumed that a constituent as an attack target is the node 903 in FIG. 9 and Threat identification number 2 “falsification of data” is selected as the threat information 400 in Step S603. Note that, in the present embodiment, since the risk level 1650 is “high”, an example of giving evaluation that is three times high is described, but the degree of reflection of a trend can be adjusted by this multiple. Further, there is also a method of reflecting a trend not by multiplication but by addition or a representative value such as an average value, a median value, a geometric mean, or a logarithmic mean.

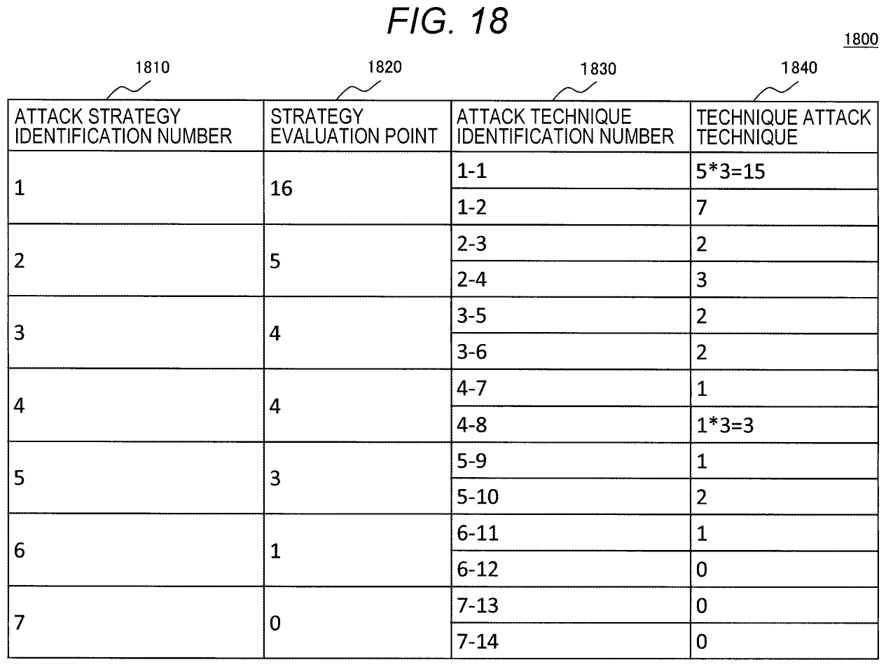

FIG. 18 illustrates the attack strategy/technique evaluation information 1800 assigned by the attack strategy/technique evaluation unit 1530 in Step S703 in a case where a notebook PC of Constituent number 1 is selected as an attack start constituent in Step S702 under the above-described condition. The attack strategy/technique evaluation information 1800 in FIG. 18 is an example in which an attack strategy identification number 1810, a strategy evaluation point 1820, an attack technique identification number 1830, and a technical evaluation point 1840 are associated with each other.

FIG. 18 illustrates an example of evaluation when the attack strategy/technique information 500 as an initial stage of an attack scenario is selected in the present embodiment. A technical evaluation point is calculated on the basis of the system configuration information 300, a stage of attack, and trend analysis information. In the example illustrated in FIG. 18, the attack technique “connection of a physical device” of the attack strategy “initial intrusion” has a highest evaluation point. This is based on the fact that it is at an initial stage of attack, and, as a characteristic of an attacker, there is a characteristic that intrusion (initial intrusion) is attempted first, and that, since a constituent of a target is a notebook PC, connection of a physical device is easy.

Furthermore, in the trend analysis information 1600, selected Group A is a group with the risk level 1650 of “high” using “fishing mail” and “remote file copy” as the used attack technique 1640. For this reason, unlike the first embodiment, a technical evaluation point is multiplied by three. Note that, in the present embodiment, since the risk level 1650 is “high”, an example of giving evaluation that is three times high is described, but the degree of reflection of a trend can be adjusted by this multiple. Further, there is also a method of reflecting a trend not by multiplication but by addition or a representative value such as an average value, a median value, a geometric mean, or a logarithmic mean.

In the present embodiment, the strategy evaluation point 1820 is calculated by adding the strategy evaluation points 1820 of a corresponding attack strategy. However, the present invention is not limited to this, and the strategy evaluation point 1820 can be given by multiplication or a difference in the technical evaluation points 1840 of a corresponding attack strategy. Alternatively, it is also possible to assign the strategy evaluation point 1120 independently of a technical evaluation point. On the basis of this evaluation point, the attack strategy/technique information 500 is selected and combined, so that an attack scenario is generated. In the present embodiment, as a selection method, one having a highest evaluation point among evaluation points at a corresponding stage is selected. In the example of FIG. 18, the attack technique “connection of a physical device” of the attack strategy “initial intrusion” is selected.

However, as a method of selecting the attack strategy/technique information 500, there is also a method of selecting the attack strategy/technique information 500 having an evaluation point equal to or more than a threshold in addition to selecting one having a largest value as described in the present embodiment. In the case of this method, even for an attack scenario regarding the same threat for the same attack start and target constituent, attack scenarios having different pieces of the attack strategy/technique information 500 included as elements are generated. Further, there is also a method of calculating an evaluation point by addition with, multiplication by, or a difference from an evaluation point up to a previous stage, or based on a representative value such as an average value, a median value, a geometric mean, or a logarithmic mean. In a case where the strategy evaluation point 1820 is assigned independently of the technical evaluation point 1840, there is also a method of first selecting an attack strategy based on the strategy evaluation point 1820 and selecting an attack technique from attack techniques in the selected attack strategies using the technical evaluation point 1840.

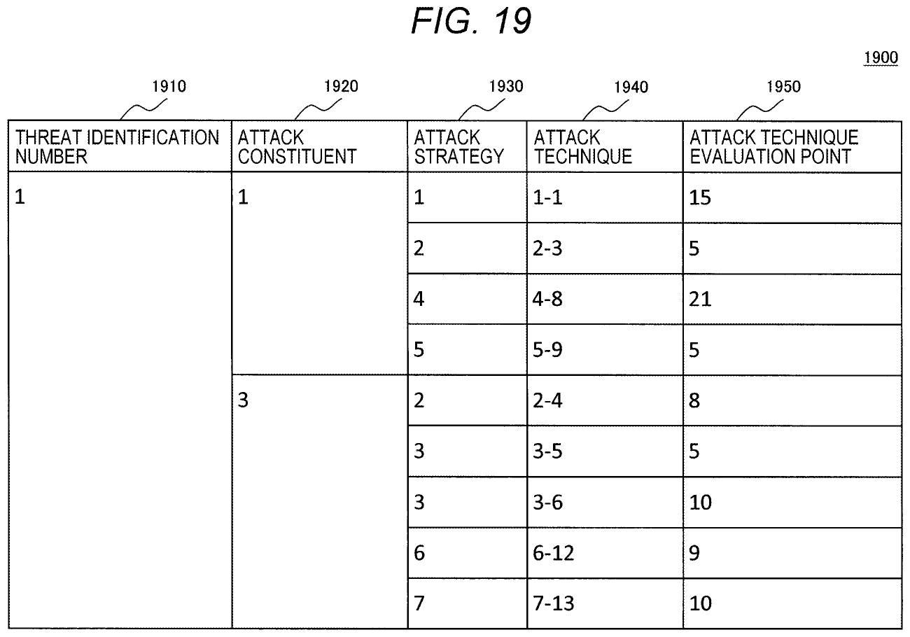

FIG. 19 illustrates an example of an attack scenario generation result 1900. The attack scenario generation result 1900 in FIG. 19 is an example of associating a threat identification number 1910 for identifying a threat corresponding to a generated attack scenario, an attack constituent 1920 indicating a constituent to be attacked, an attack strategy 1930, an attack technique 1940, and a technique evaluation point 1950. In the present embodiment, the attack strategy/technique information 500 having a highest evaluation point is selected from the attack strategy/technique evaluation information 1800 in each attack stage.

A screen display example of the attack scenario output unit 109 in the present embodiment is similar to that in FIG. 14 of the first embodiment. However, in the rearrangement and the display switching, rearrangement and switching reflecting a trend can be performed. In a specific example, in the rearrangement, when attack scenarios reflecting a trend of a plurality of groups are output, the attack scenarios can be rearranged according to the risk level 1650. Further, also in display switching, display content can be switched using the attack group 1620 and the risk level 1650.

### Third Embodiment

Hereinafter, a third embodiment according to the present invention will be described with reference to the accompanying drawings.

In the first and second embodiments, description is performed with the number of attack techniques limited to 14. However, the number of actual attack techniques is large, and there are 260 or more attack strategies in the knowledge base Adversarial Tactics, Techniques, and Common Knowledge: ATT&CK® (registered trademark in the United States) that summarizes attack techniques developed by the Mitre Corporation in the United States. For this reason, it is easy to imagine that the number of attack techniques further increases due to future technological development. In the present invention, since an attack scenario is generated by a combination of attack techniques, there is a concern about explosion of the number of combinations and the number of attack scenarios that can be generated. For this reason, in order to reduce explosions of the number of combinations, in the present embodiment, the attack scenario generation method in which a function of narrowing down the attack strategy/technique information 500 at the time of input to the attack strategy/technique storage unit 104 is added will be described.

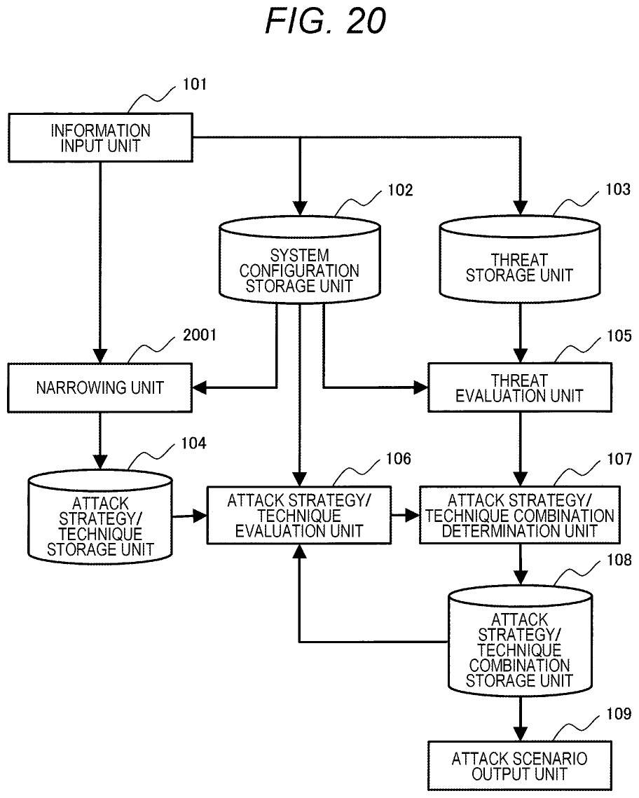

The present embodiment is different in that the information from the information input unit 101 is narrowed down by a narrowing unit 2001 and stored in the attack strategy/technique storage unit 104 in the attack scenario generation device of FIG. 1 described in the first embodiment. FIG. 20 illustrates a functional block diagram illustrating an example of a functional configuration of the scenario generation device 20 of the present embodiment. In FIG. 20, reference numerals 101 to 109 are the same as those in FIG. 1.

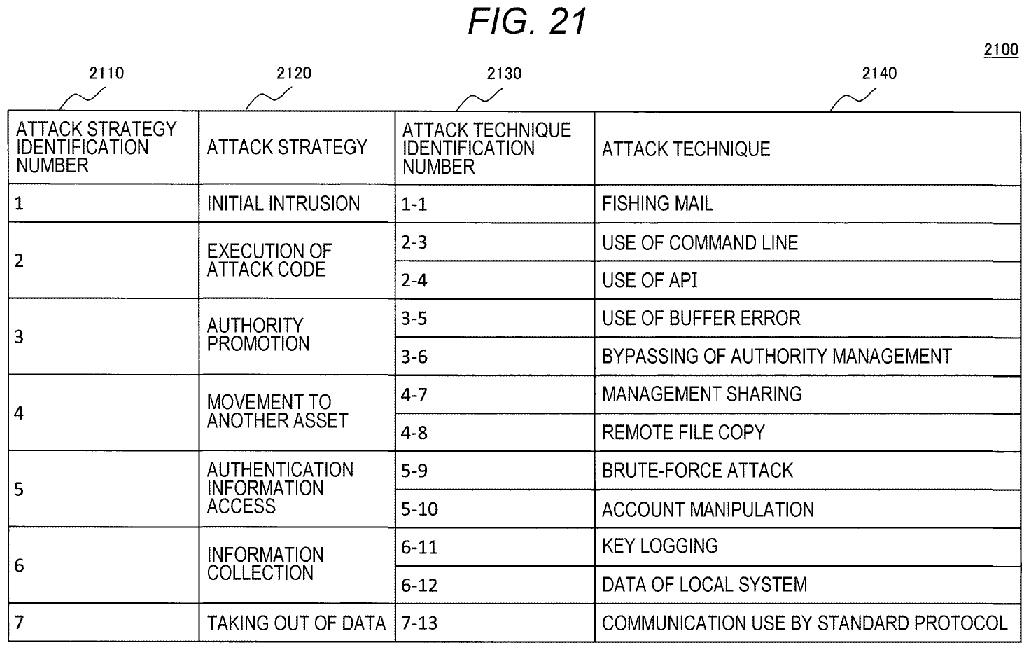

A specific method of narrowing down will be described with reference to FIG. 21. FIG. 21 is a diagram illustrating the attack strategy/technique information 2100 stored in the attack strategy/technique storage unit 104 when the narrowing is performed for the data server 1 in FIG. 8 on the basis of the system configuration information 300. The attack strategy/technique information 2100 includes an attack strategy identification number 2110, an attack strategy name 2120, an attack technique identification number 2130, and an attack technique name 2140. The attack strategy name is an assumed attack strategy, and in the case of the example of FIG. 21, there are an initial intrusion, execution of an attack code, authority promotion, movement to another element, authentication information access, information collection, and taking out of data. The attack technique name 2140 is a technique for realizing an attack strategy, and in the case of the example of FIG. 3, items below are included as the attack technique name 2140.
Fishing mail
Use of a command line and use of an Application Programing Interface (API)
Use of a buffer error
Bypassing of authority management
Management sharing
Remote file copy
Brute-force attack or account manipulation
Key logging
Data of a local system
Use of communication in a standard protocol

What is different from the attack strategy/technique information 500 in FIG. 5 is that the attack technique does not include “connection of a physical device” or “taking out by a physical device”. This refers to the physical access 390 of the system configuration information 300 of FIG. 3, and the data server 1 cannot perform physical access. For this reason, this is an example in which “connection of a physical device” and “taking out by physical device” that require connection of a physical devices are determined to be unrealizable attack techniques, and narrowing not to be stored in the attack strategy/technique storage unit 104 is performed. As described above, by narrowing down attack techniques that are candidates for generating an attack scenario, it is possible to realize time and the number of combinations necessary for evaluation. Note that, in the present embodiment, narrowing down for the data server 1 and a single constituent is described, but there is also a method of extracting features of the entire system and perform narrowing down from the features. Specific features of the entire system include the OS (basic software) 360 is the same, the physical access 390 is difficult or easy for all constituents, and the like. Further, narrowing may be performed using not only the system configuration information but also a result of trend analysis described in the second embodiment. Specifically, a single or a plurality of attack groups may be selected according to the attack target field 1610 or the risk level 1650, and narrowing may be performed by the used attack technique 1640 of them. As described above, in the present embodiment, narrowing is performed according to a predetermined criterion.

The description of the embodiments of the present invention is thus completed. Note that the present invention is not limited to the above embodiments and includes a variety of variations. The above embodiments are described in detail in order to describe the present invention in an easy-to-understand manner. For this reason, for example, content of information stored in each storage unit, processing of giving a constituent risk level evaluation point for each constituent, an extraction result of an attack scenario, an evaluation result, and the like are not necessarily limited to all the configurations, processing, information, and numerical values described above.

Further, a part or the whole of the above configurations, functions, processing units, processing means, and the like may be obtained as hardware by way of, for example, designing them as an integrated circuit. Further, the above configurations, functions, and the like may be obtained by software by which the processing unit 11 interprets and executes programs that perform functions of them as illustrated in FIG. 19. Information, such as a program that performs each function, a table, and a file, can be stored in recording devices, such as a memory, a hard disk, and a solid state drive (SSD), or recording media, such as an IC card, an SD card, and a DVD.

### REFERENCE SIGNS LIST

102 system configuration storage unit
103 threat information storage unit
104 attack strategy/technique storage unit
105 threat evaluation unit
106 attack strategy/technique evaluation unit
107 attack strategy/technique combination determination unit
108 attack strategy/technique combination storage unit
109 attack scenario output unit
300 system configuration information
400 threat information
500 attack strategy/technique information
1200 attack scenario generation result
1400 display example of attack scenario generation result

1. A cyber attack scenario generation method using a scenario generation device that generates a scenario of a cyber attack on a computer system, the cyber attack scenario generation method comprising:
reading, from a storage device, a plurality of pieces of attack strategy/technique information in which an attack strategy indicating an action for executing the cyber attack and an attack technique indicating a method of realizing the attack strategy are associated;
evaluating effectiveness of a cyber attack in each of the plurality of pieces of attack strategy/technique information; and
identifying a combination of the attack strategy/technique information according to a result of the evaluation, and generating an attack scenario configured by an identified combination.

2. The cyber attack scenario generation method according to claim 1, further comprising:
evaluating, for each constituent of the computer system, a threat indicating a final goal of an attacker in the cyber attack stored in the storage device; and
generating the attack scenario by using an evaluation result for the attack strategy/technique information and an evaluation result for the threat.

3. The cyber attack scenario generation method according to claim 2, further comprising:
analyzing a trend of the cyber attack; and
using an analysis result of the trend in evaluation for the attack strategy/technique information and evaluation for the threat.

4. The cyber attack scenario generation method according to claim 1, further comprising:
executing narrowing processing on the attack strategy/technique information according to a predetermined criterion; and
executing evaluation of the attack strategy/technique information on the attack strategy/technique information on which the narrowing processing is executed.

5. The cyber attack scenario generation method according to claim 1, further comprising:
generating a plurality of attack scenarios; and
outputting a plurality of generated scenarios according to a result of the evaluation.

6. A scenario generation device that generates a scenario of a cyber attack on a computer system, the scenario generation device comprising:
an information input unit that reads, from a storage device, a plurality of pieces of attack strategy/technique information in which an attack strategy indicating an action for executing the cyber attack and an attack technique indicating a method of realizing the attack strategy are associated;
an attack strategy/technique evaluation unit that evaluates effectiveness of a cyber attack in each of the plurality of pieces of attack strategy/technique information; and
an attack strategy/technique combination determination unit that identifies a combination of the attack strategy/technique information according to a result of the evaluation in the attack strategy/technique evaluation unit, and generates an attack scenario configured by an identified combination.

7. The scenario generation device according to claim 6, further comprising:
a threat evaluation unit that evaluates a threat indicating a final goal of an attacker in the cyber attack stored in the storage device for each constituent of the computer system, wherein
the attack strategy/technique combination determination unit generates the attack scenario by using an evaluation result for the attack strategy/technique information and an evaluation result for the threat.

8. The scenario generation device according to claim 7, wherein
a trend of the cyber attack is analyzed, and
an analysis result of the trend is used in evaluation for the attack strategy/technique information and evaluation for the threat.

9. The scenario generation device according to claim 6, further comprising:
a narrowing unit that executes narrowing processing on the attack strategy/technique information according to a predetermined criterion, wherein
the attack strategy/technique combination determination unit executes evaluation of the attack strategy/technique information on the attack strategy/technique information on which the narrowing processing is executed.

10. The scenario generation device according to claim 6, wherein
the attack strategy/technique combination determination unit generates a plurality of attack scenarios, the scenario generation device further comprising:
an output unit that outputs a plurality of generated scenarios according to a result of the evaluation.
